(19) United States
(12) Patent Application Publication
(10) Pub. No.: US 2012/0098617 A1
(43) Pub. Date: Apr. 26, 2012

(54) Wilkinson Coupler Integrated into a Printed Circuit and Microwave Device Comprising Such a Coupler

(75) Inventors: Claude Drevon, Toulouse (FR); David Nevo, Toulouse (FR); Laurent Bodin, Saulny (FR)

(73) Assignee: THALES, Neuilly-sur-Seine (FR)

(21) Appl. No.: 13/377,562

(22) PCT Filed: Jun. 21, 2010
(86) PCT No.: PCT/EP2010/058707

§ 371 Date: Dec. 11, 2011

(30) Foreign Application Priority Data
Jul. 7, 2009 (FR) 09 03345

(51) Int. Cl. H01P 5/12

(52) U.S. Cl. 333/128

(57) ABSTRACT

A Wilkinson coupler mounted on a printed circuit comprises a first access port connected to a second access port and to a third access port by way of two metallic transmission lines of the same length and a load resistor mounted in short-circuit arrangement between the second and third access ports, characterized in that the load resistor is constituted of three adjacent independent resistors linked together. The coupler applies notably to the field of satellite antennas and more particularly to antenna beamforming arrays.

The present invention relates to a Wilkinson coupler integrated into a printed circuit and to a microwave device comprising such a coupler. It applies notably to the field of microwave signal telecommunications such as notably to radiofrequency chains and to the beamforming arrays of transmit and receive antennas, for example antennas stationed aboard a satellite.

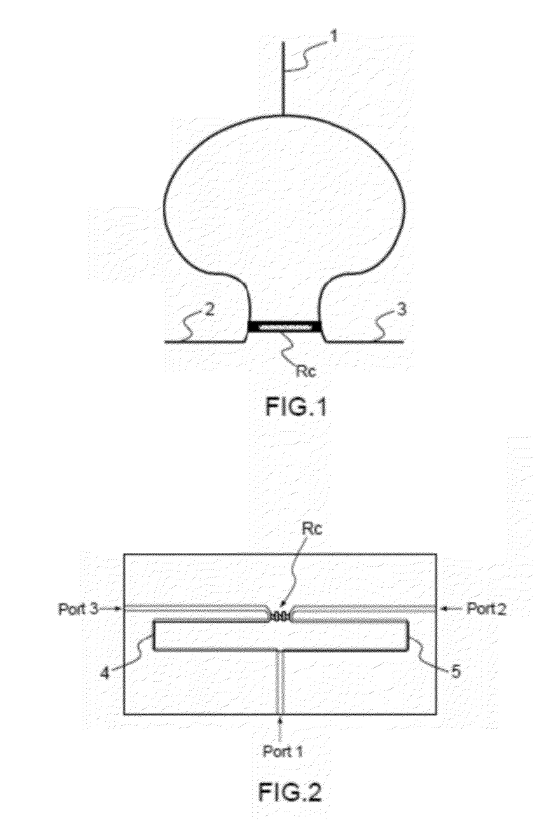

It is known to use Wilkinson couplers for combining or dividing radiofrequency signals. As represented schematically in FIG. 1, this type of coupler comprises three accessways 1, 2, 3 constituting, in the divider configuration, an input port 1 and two output ports 2, 3, the input and output ports being inverted in the case where the coupler is used in the combiner configuration. The coupler is terminated in a load resistor Rc mounted between the two output ports 2, 3. The value of the load resistor Rc is determined in such a way that the coupler is balanced and that there is no reflection at input or at output. In the field of transmit and receive antennas, certain equipment such as beamforming arrays need the value of the load resistor to have an accuracy of between 1 and a few percent.

At present, it is known to insert a resistor into a multilayer printed circuit by a photolithography method comprising a double etching. This type of method does not make it possible to obtain a resistor whose value has the required accuracy. It is therefore fundamental to be able to measure and adjust this load resistor with the required accuracy.

It is known to adjust the value of a resistor by means of a laser installation and to measure this value during laser machining as described for example in the document US 2007/0012666, however, the load resistor of a Wilkinson coupler being placed in short-circuit arrangement between the two output ports, it is not traversed by any current and there is at present no process making it possible to measure it. This method is not therefore at present applicable to the Wilkinson coupler since it is not known how to measure the value of the load resistor during adjustment.

To solve this problem, instead of producing the resistor Rc by a photolithography method, it is known to use an electronic component (called a chip) containing a resistor of accurate value and to solder the resistor, between the two access ports 2, 3 of the coupler, inside a layer of a multilayer printed circuit during the fabrication of the printed circuit. However, to be able to insert the resistor Rc into the multilayer printed circuit on which the Wilkinson coupler is mounted, it is necessary to open the printed circuit and then to embed the resistor in a dielectric material. Moreover, during production of the multilayer printed circuit, the soldering material must be brought to a high soldering temperature, this being difficult to achieve on an organic substrate such as the dielectric of a multilayer printed circuit; for example the soldering temperature is of the order of 290° Celsius for a gold-tin alloy soldering material compatible with the gold-coated terminations of such resistors. This method is complex and expensive to implement and presents risks in relation to quality especially as these operations must generally be carried out for a very large number, for example of the order of a thousand, of individual resistors. Furthermore, the total thickness of the printed circuit obtained is greatly increased because of the thickness of the electronic component which must be shrouded in sufficient dielectric material. Finally, after soldering of the resistor between two ports of the Wilkinson coupler, it is no longer possible to carry out measurements of the resistor, thereby presenting a risk from a quality point of view, especially as the solder joint will undergo stresses from pressure and temperature during the fabrication of the multilayer printed circuit.

Another solution described in the document U.S. Pat. No. 5,705,962 uses a midpoint by separating the load resistor into two resistors with a metallic track. This makes it possible to have, for the measurement, two resistors in parallel. However this solution does not make it possible to measure the value of each of the resistors individually but only the value of a ratio between the two resistors in parallel. This system does not therefore allow sufficient accuracy, nor exact measurement of the total load resistance. Furthermore, this solution requires that a metallized hole be made in the printed circuit, this taking up a great deal of space when dealing with complex circuits comprising a very significant number of Wilkinson couplers.

The aim of the invention is to produce a Wilkinson coupler integrated into a printed circuit not comprising the drawbacks of the existing devices, not requiring the machining of metallized holes in the printed circuit for the measurement of the load resistor and having a load resistor whose value may be adjusted with a required accuracy and measured during its adjustment.

Hence, the invention relates to a Wilkinson coupler mounted on a printed circuit comprising a first access port connected to a second and a third access port by way of two metallic transmission lines of the same length and a load resistor mounted in short-circuit arrangement between the second and third access ports, characterized in that the load resistor is constituted of three adjacent independent resistors linked together.

Advantageously, each resistor has an individually adjustable and measurable value.

Advantageously, each resistor is measurable during the adjustment.

Advantageously, the three independent resistors are linked by way of two transverse metallic tracks, each transverse metallic track being disposed between two adjacent resistors.

Advantageously, the first resistor is connected between a first metallic end terminal linked to a metallic line for access to the third port and the first transverse track and in that the third resistor is linked between the second transverse track and a second metallic end terminal linked to a metallic line for access to the second port.

Advantageously, the first and the second metallic end terminals are linked together by way of the two metallic transmission lines connected to the first port, the two transmission lines forming a metallic track linked in a loop.

Advantageously, the three independent resistors are connected in a triangle.

According to a particular embodiment, the three independent resistors have an identical value equal to a third of the value of the desired load resistor.

The invention also relates to a microwave device comprising at least one such Wilkinson coupler.

Other features and advantages of the invention will become clearly apparent in the subsequent description given by way of purely illustrative and nonlimiting example, with reference to the appended schematic drawings which represent:

FIG. 1: a diagram of an exemplary Wilkinson coupler, according to the prior art;

FIG. 2: a diagram of an exemplary Wilkinson coupler, according to the invention;

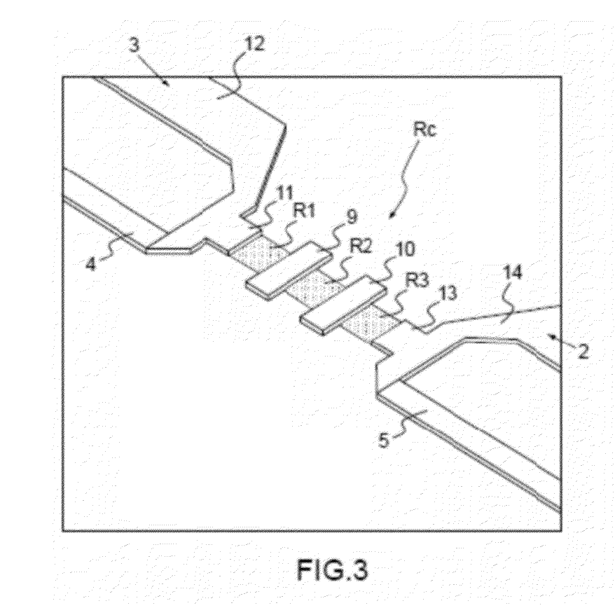

FIG. 3: a diagram of a magnification of the load resistor of the Wilkinson coupler of FIG. 2, according to the invention;

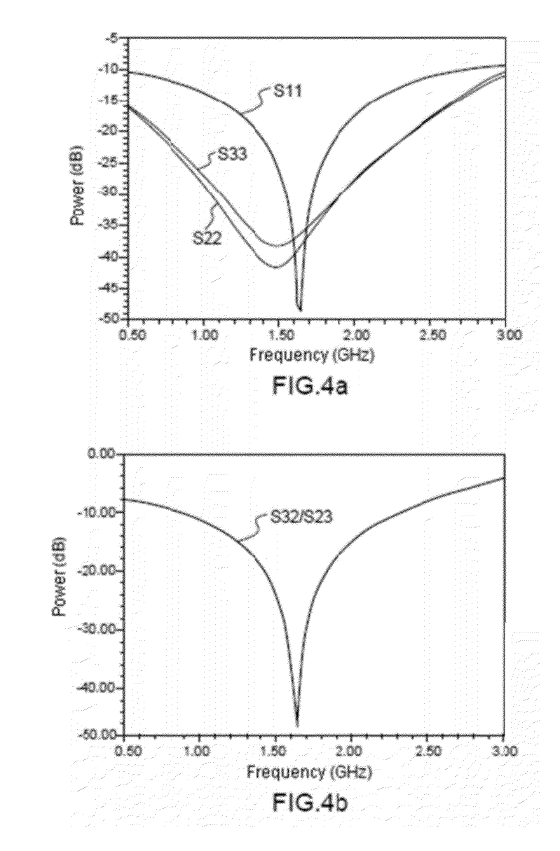

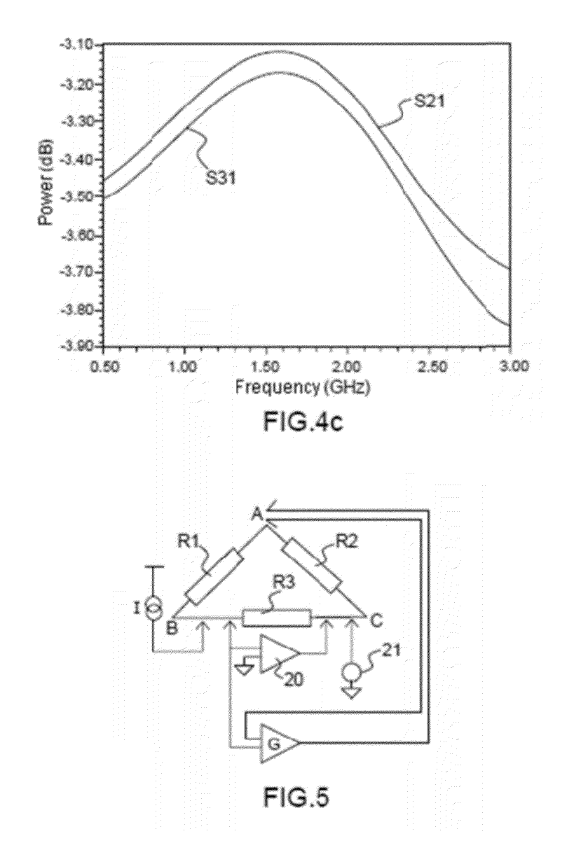

FIGS. 4a to 4c: an example of the curves of powers in transmission and in reflection on the three accessways of a coupler, according to the invention;

FIG. 5: an exemplary electrical diagram of a device for measuring the load resistor of a Wilkinson coupler, according to the invention;

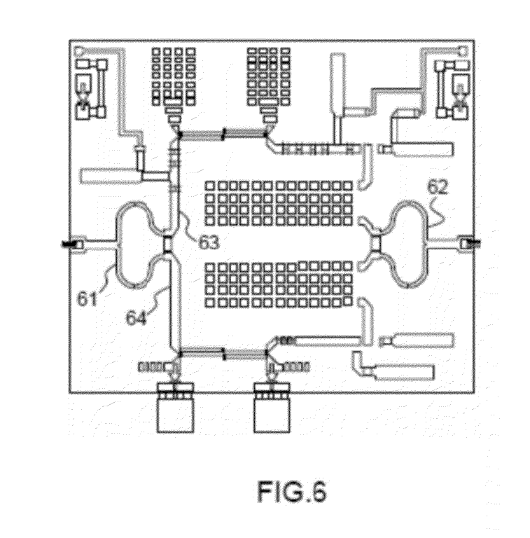

FIG. 6: an exemplary microwave device comprising two Wilkinson couplers.

The exemplary coupler according to the invention, represented schematically in FIG. 2, comprises three accessways 1, 2, 3 constituting, in the divider configuration, an input port 1 and two output ports 2, 3. The input port 1 is linked to the two output ports 2, 3 by way of two metallic transmission lines 4, 5 of length λ/4 and of characteristic impedance Z=2^{1/2}R, λ being the wavelength corresponding to the operating frequency of the coupler, R being the impedance of the input accessway 1 and output accessways 2, 3. So that the incident power entering the port 1 is divided in an equal manner between the output ports 2 and 3 which are then mutually isolated, it is necessary that the coupler be terminated in a load resistor Rc equal to twice the impedance R of the accessways of the coupler Rc=2R, the resistor Rc being mounted between the two output ports 2, 3. The coupler and the load resistor are produced by a known method of photolithography on a multilayer printed circuit comprising a substrate covered with a resistive layer and with a metallic layer, for example of copper. A first etching makes it possible to produce the transmission lines of the coupler and a second etching makes it possible to produce the load resistor of the coupler.

The load resistor Rc, mounted in short-circuit arrangement, must be able to be measured and adjusted accurately. Hence, in accordance with the invention, the load resistor Rc of the coupler consists of an array of three adjacent resistors R1, R2, R3 separated by way of two transverse metallic tracks 9, 10, the metal possibly being copper for example. A first resistor R1 is connected between a first metallic end terminal 11 linked to a metallic line 12 for access to the port 3 and a first transverse track 9, a second resistor R2 is connected between the first transverse track 9 and a second transverse track 10, the third resistor R3 is linked between the second transverse track 10 and a second metallic end terminal 13 linked to a metallic line 14 for access to the port 2. Furthermore, the first and the second metallic end terminals 11, 13 are linked together by way of the two transmission lines 4, 5 connected to the port 1, the two transmission lines 4, 5 forming a metallic track linked in a loop. Each of the resistors R1, R2, R3 of the array of resistors has an intrinsic value such that the sum of the values of the three independent resistors R1, R2, R3 is equal to the value of the load resistor Rc. For example, although this is not indispensable, the three resistors R1, R2, R3 may be identical and have a value equal to a third of the value of the load resistor Rc.

Splitting the load resistor Rc into three resistors R1, R2, R3 makes it possible to change nothing from the point of view of the microwaves which feed the coupler, the three adjacent resistors R1, R2, R3 behaving as a single short-circuited resistor Rc whose value is equal to the sum of the values of the three resistors. Because of the short-circuit, the three resistors R1, R2, R3 may be considered to be an array of resistors connected in a triangle. The influence of the splitting of the load resistor Rc into three resistors R1, R2, R3 on the performance of the coupler has been verified by simulations.

The transmission and reflection power curves for the three accessways of the coupler are represented in FIGS. 4a, 4b, 4c. FIG. 4a, shows that the reflection coefficients S11, S22, S33 of a signal applied respectively to the ports 1, 2 or 3 are very low at the central operating frequency of the coupler. In particular, in FIG. 4a, the coefficient S11 is of the order of −48 dB at the frequency of 1.6 GHz. Consequently, when a signal is applied to the input port 1, there is no reflection of this signal which is fully transmitted to the ports 2 and 3.

FIG. 4b shows that at the operating frequency, the coefficients S23 of transmission of the signal from the port 2 to the port 3 and vice versa S32 are almost zero. The ports 2 and 3 are therefore perfectly isolated from one another.

FIG. 4c shows the coefficients S21 and S31 of transmission between the ports 1 and 2 and between the ports 1 and 3. The power transmitted between the outputs 2 and 3 and the input 1 are almost equal, thereby signifying that the coupler is correctly balanced. The observed discrepancy between the two curves are due to divergences of calculation of the simulator used.

From the point of view of the possibility of measurement of the load resistor, the splitting of the load resistor Rc into three adjacent resistors and the addition of two metallic tracks 9, 10 between two adjacent resistors R1, R2 and R2, R3 makes it possible to be able to connect a metallic connection pin to each of the two transverse tracks 9, 10 and a metallic pin to one of the tracks 11, 13 short-circuiting the load resistor Rc. It then becomes possible to wire up a measurement apparatus, for example of ohmmeter type, between the three connection terminals 11, 9, 10 and to accurately measure, successively, the value of each of the three resistors R1, R2, R3.

To carry out the measurement, one of the three connection terminals is called the guard point. The voltage is calculated and forced at this guard point so that there is no current in one of the three resistors which is not measured, as represented in the exemplary electrical diagram of FIG. 5. In this figure, the guard point is the point A situated between a first resistor R1 and a second resistor R2 and the measured resistor is a third resistor R3. The resistor R3 comprises a first end connected to the resistor R1 at a point B and a second end connected to the resistor R2 at a point C. A current source I is applied to the point B. A guard amplifier G having a first input connected to the point B, a second input connected to the point A and an output connected to the point A, detects the voltage at the first end B of the resistor R3 and applies this voltage at the guard point A. The voltage at the guard point A and at the point B are then equal and there is therefore no current in the resistor R1. The resistors R3 and R2 then form a conventional measurement bridge. If Im is the current which flows in the resistor R3, the current Ig which flows in the resistor R2 is such that:

R3. Im=R2. Ig

An amplifier 20 connected between the points B and C makes it possible, on its output at the point C, to return a voltage proportional to a current I which is injected at the point B and which crosses the resistor R3. A converter 21 then determines the value of the resistor R3 by virtue of the ratio between the voltage at the point C that it measures and the known value of the current I.

The value of the resistor R1 may be determined in the same manner by swapping the guard point and the measurement points.

The value of each of the resistors R1, R2, R3 can then be adjusted independently of the other two resistors so as to have a total resistor having a value equal to the desired load resistor value Rc. It is also possible to measure each of the resistors R1, R2, R3 independently and to adjust just one of them. The adjustment of the value of the resistors may be carried out by a known method of adjustment by laser beam, the measurement of the resistor undergoing adjustment being carried out continuously during the adjustment of this resistor. For example, the laser may be similar to those used for the adjustment of thin film or thick film resistors. Its wavelength can for example be chosen of the order of 1.07 micrometers. The power of the laser beam is programmed as a function of the material to be adjusted and of the support of the resistor. It will be possible to choose for example a scaled down YAG laser operating in the infrared and having of the order of 3 Watts of power. The support of the resistor may for example be of ceramic or organic material, or of some other type of material customarily used in the field of printed circuits.

The Wilkinson coupler may be used in any type of microwave device such as for example in the equipment of telecommunication signals transmit and receive radiofrequency chains, notably in the beamforming arrays of multi-beam antennas or in the linearization modules fitted to circuits for amplifying telecommunication signals. By way of nonlimiting example, FIG. 6 shows a diagram of a linearizer comprising two Wilkinson couplers 61, 62. The first coupler 61 is a divider of the power of the input signals between two output transmission pathways 63, 64 whereas the second coupler 62 recombines the power of the signals processed on each of the pathways into a single output signal.

Although the invention has been described in conjunction with particular embodiments, it is quite obvious that it is in no way limited thereto and that it comprises all the technical equivalents of the means described as well as their combinations if the latter enter within the framework of the invention.

1. A Wilkinson coupler integrated into a printed circuit comprising: a first access port connected to a second access port and to a third access port by way of two metallic transmission lines of the same length and a load resistor mounted in short-circuit arrangement between the second and third access ports, wherein the load resistor is constituted of three adjacent independent resistors linked together.

2. The Wilkinson coupler as claimed in claim 1, wherein each independent resistor has an individually adjustable and measurable value.

3. The Wilkinson coupler as claimed in claim 2, wherein each independent resistor is measurable during the adjustment.

4. The Wilkinson coupler as claimed in claim 3, wherein the sum of the values of the three adjacent independent resistors is equal to the value of the load resistor

5. The Wilkinson coupler as claimed in claim 1, wherein the three independent resistors are linked by way of two transverse metallic tracks each transverse metallic track being disposed between two adjacent independent resistors.

6. The Wilkinson coupler as claimed in claim 5, wherein a first independent resistor is connected between a first metallic end terminal linked to a metallic line for access to the third port and the first transverse track and a third independent resistor is linked between the second transverse track and a second metallic end terminal linked to a metallic line for access to the second port.

7. The Wilkinson coupler as claimed in claim 6, wherein the first and the second metallic end terminals are linked together by way of the two metallic transmission lines connected to the first port, the two transmission lines forming a metallic track linked in a loop.

8. The Wilkinson coupler as claimed in claim 1, wherein the three independent resistors are connected in a triangle.

9. The Wilkinson coupler as claimed in claim 1, characterized in that wherein the three independent resistors have an identical value equal to a third of the value of the desired load resistor.

10. A microwave device comprising at least one Wilkinson coupler as claimed in claim 1.
